(19) United States
(12) Patent Application Publication
(10) Pub. No.: US 2007/0289975 A1
(43) Pub. Date: Dec. 20, 2007

(54) Vessel Comprising Two Compartments And Connection, One Compartment Is Defilled And The Other Is Filled

(76) Inventors: Wolfgang Schmehl, Hamburg (DE); Fridtjof Schucht, Krefeld (DE); Peter Forsberg, Ottobrunn (DE)

Correspondence Address: FISH & RICHARDSON PC, P.O. BOX 1022, MINNEAPOLIS, MN, 55440-1022, US

(21) Appl. No.: 11/578,685

(22) PCT Filed: Apr. 15, 2005
(86) PCT No.: PCT/EP05/04035

§ 371 Date: Jul. 20, 2007

(30) Foreign Application Priority Data
Apr. 16, 2004 (EP) 04009159.7

(51) Int. Cl. F17C 13/06

(52) U.S. Cl. 220/582; 222/3

(57) ABSTRACT

The present invention relates to a vessel for dispensing and recovering of technical and medical gases and system for delivery and recovery of technical and medical gases.

### BACKGROUND OF THE INVENTION

The present invention relates to a vessel for dispensing and recovering of technical and medical gases and a system for delivery and recovery of technical and medical gases. In particular it relates to the delivery and recovery of breathing gases for medical purposes.

The use of technical and medical gases in many cases requires the recovery of the gases after use.

For toxic and environmentally hazardous gases such as, e.g., carbon monoxide (CO), nitric oxide (NO), halogens, e.g., chlorine gas, etc. the recovery of the gases after use is frequently required by laws and regulations, for example, in connection with the Kyoto Protocol.

For rare and/or expensive gases like noble gases, e.g., xenon (Xe), neon (Ne), argon (Ar), krypton (Kr), helium (He) or isotopes thereof, or gases such as oxygen (O₂) or carbon dioxide (CO₂), sulfur hexafluoride (SF₆), carbon fluoromethane (CF₄), perfluorocarbons, etc. there is often an economical or safety reason to recover the gases.

Known systems for delivery and recovery of a gas comprise a unit for the delivery of the gas and a separate system for the recovery of the used gas.

For example in a medical environment a system for delivery and recovery of a medical gas comprises a unit for delivery of the gas to a patient and a separate system for the recovery or evacuation of the used gas.

The recovery systems typically provide purifying and/or high pressure compression facilities. These facilities are on the one hand very expensive and on the other hand need trained staff for monitoring and maintenance.

For example, purifying may be performed by the use of cooling, filtering and absorbing units. These systems require monitoring, since they employ cooling agents as well as pressurized units.

Furthermore, cooling and absorbing agents and filters should be substituted at specific intervals. In addition, systems employing pressurized components should be handled with care.

However, many of these systems are intended for use by persons having no specific technical training.

For example in a medical environment, the medical staff is typically not trained in the maintenance or monitoring of these units.

Additionally, in emergency medicine it is frequently required that the equipment is small-sized and ready to use immediately.

European Patent EP 0 938 448 B1 describes how air exhaled from a patient under anaesthesia can be collected in plastic bags used for collecting gaseous samples, afterwards compressed into cylinders, and sent to a different location for treating and recovering the anaesthetic gas.

U.S. Pat. No. 4,945,906 discloses a system for administering anaesthetics whereby a suction pressure is created around a breathing mask to collect exhaled gas that otherwise would escape to the surrounding atmosphere. An extraction system will then transport the exhaled gas from the operating room via a central evacuation duct out of the building.

German Utility Model DE 298 178 24 U1 discloses a system having adsorption units for adsorbing xenon (Xe) comprised in the exhaled gas during anaesthesia. After a first adsorption during which the gas is pumped into zeolite filters, the residual gas is gathered for further purification or is released to the ambient atmosphere.

In European Patent EP 0 921 846 B1 an on-line recovery system is disclosed, in which the exhaled anaesthetic gas is purified through a condensation and heating procedure. The purified anaesthetic gas is then reintroduced into the anaesthesia machine.

WO 03/093722 A1 discloses a container for gas recovery having an inner and an outer compartment separated by a flexible wall. One disadvantage of this container is that it is not suitable for highly compressed gases. Furthermore, the container is not adapted to be set up in a simple and rapid way within a gas delivery and recovery system. Also, the compartments cannot be separately removed, e.g., during maintenance.

The techniques and apparatuses of the prior art as cited above are characterized by the presence of purifying units, which are conventionally optimised for the use with a specific gas.

Moreover, the employment of the specific purification techniques described therein frequently requires considerable technical effort, e.g., the presence of cooling or absorbing units for the isolation of a specific gas from the gas mixture.

However, as mentioned above, these devices are intended for use by persons having no specific technical training. For example, in a medical environment the medical staff typically is not trained in maintenance or monitoring these apparatuses.

Thus, there is a need for easy-to-use apparatuses, which do not require extensive or complicated monitoring and maintenance activity.

Additionally, there is a need for equipment that can be rapidly activated and operated in a straightforward manner, so that it is immediately ready to use, e.g., for the purposes of emergency medicine.

It is therefore an object of the invention to provide a vessel for dispensing and recovering of technical and medical gases and a system therefore with reduced or simplified maintenance and monitoring requirements.

It is a further object of the invention to provide a vessel for dispensing and recovering of technical and medical gases and a system therefore, which are simple and easy to use.

### SUMMARY OF THE INVENTION

The present invention relates to a vessel for dispensing and recovering technical and/or medical gases, in particular, dispensing and recovering breathing gases for medical purposes, and a system therefore.

More particularly, the present invention relates to a vessel for dispensing and recovering of gases, in particular technical and medical gases, the vessel comprising:
a first compartment for storing and dispensing a gas, and a second compartment for recovering and storing a gas, and
coupling means for providing a connection to deliver gas from said first compartment and for providing another connection to feed gas into said second compartment,
characterized in that
said compartments are separated by a rigid wall.

Alternatively, or in addition, the vessel according to the present invention is characterized in that said second compartment comprises an adsorbent capable of adsorbing the gas to be recovered. In a preferred embodiment, the gas to be recovered is the gas stored in the first compartment.

The present invention also relates to a system for the delivery and recovery of gases for medical or technical applications, said system comprising
a vessel for dispensing and recovering of gases as described herein, and
means for delivering the gas from the first compartment of the vessel for an application, and
means for recovering gas from the application, and
means for conducting gas from and to the vessel.

### BRIEF DESCRIPTION OF THE FIGURES

The figures show the following:

FIG. 1a, 1b, 1c and 1d a schematic view of four alternative embodiments of a vessel according to the invention;

FIG. 2a and 2b a plan view onto the end of the coupling showing two alternatives of coupling means according to the invention;

FIG. 3 a system for delivery and recovery of a gas in an application comprising a vessel according to the invention;

FIG. 4 a preferred embodiment of a vessel according to the present invention;

FIG. 5 the preferred embodiment of FIG. 4 with the outer casing removed; and

FIG. 6 a preferred embodiment of the coupling means.

### DETAILED DESCRIPTION OF THE INVENTION

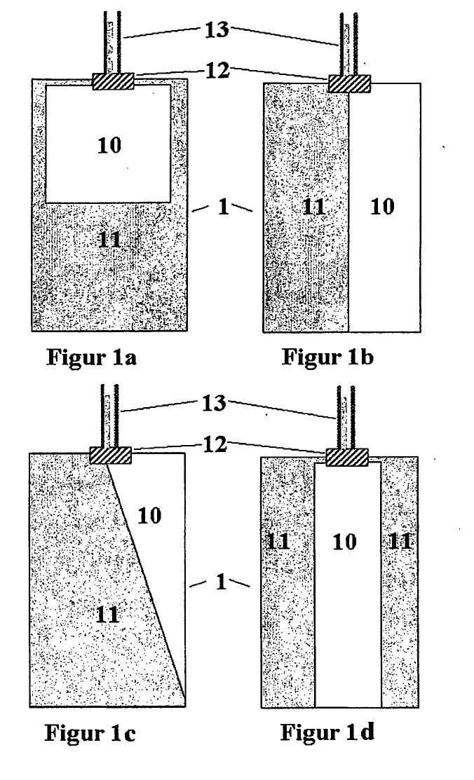

FIG. 1a, 1b, 1c and 1d show schematic views of four alternative embodiments of a vessel 1 according to the invention.

A vessel 1 according to the invention comprises two compartments 10, 11. An advantage over prior art vessels is the fact that these compartments may be arranged in several ways, thus providing increased flexibility in the design of the vessel.

For example, as shown in FIG. 1a and FIG. 1d a vessel 1 may have two compartments 10, 11, wherein the first compartment 10 is located within or encompassed by the second compartment 11. Alternatively, as shown in FIG. 1b and 1c the two compartments 10, 11 may be located adjacent to each other.

The compartments 10 and 11 of the vessel of the invention are separated by a gas impermeable rigid wall. The rigid wall may comprise reinforcements and may feature different shapes.

For example the rigid wall shown in FIG. 1b is perpendicular to the bottom. However, also other arrangements, for example a rigid wall having an angle other than being perpendicular to the bottom as shown in FIG. 1c, or having a rounded or spherical shape are likewise possible.

In certain embodiments either the first compartment 10 or the second compartment 11 are removably connected to the vessel so that either the first or the second compartment may be separately removed therefrom. This has the advantage that only one of the two compartments has to be removed during maintenance in a situation where removal of the other compartment is not (yet) necessary. For this purpose either compartment may provide coupling means. The coupling means is either a quick coupling or a threaded coupling.

When using a vessel having both compartments 10, 11 being removable a further advantage of the invention is that the compartments 10, 11 can be sent to different sites. For example a second compartment 11 comprising the used gas can be sent to a cleaning and recycling site, whereas an empty first compartment 10 for fresh gas can be sent to a different site for refilling.

For example, as shown in FIG. 1d, the first compartment 10 may be surrounded on three sides by the second compartment 11, allowing to remove the first compartment 10 from the second compartment 11.

The compartments 10, 11 may have different volumes. For example as shown in FIG. 1a, 1b, 1c, 1d the volume of the first compartment 10 may be smaller than that of the second compartment 11.

Additionally the compartments may be designed for different pressure ranges.

For example in FIG. 1a compartment 10 may be designed for a larger pressure range, whereas the compartment 11 may be designed for a lower pressure range.

In a preferred embodiment the first compartment 10 is designed to dispense a gas or a gas mixture, e.g., it may be a canister for pressurized gas, whereas the second compartment 11 is designed for receiving and storing a gas or a gas mixture, in particular comprises at least a part of the gas dispensed by the first compartment. Compartment 10 will typically have a smaller volume than compartment 11.

Furthermore the first compartment 10 may be designed to withstand a larger pressure than the second compartment 11. By enclosing compartment 10 within compartment 11, additional protection for the compartment having the higher pressure is provided.

In a preferred embodiment the first compartment is designed for a pressure range from 10 to 200 bar. More preferably, it is designed for a pressure up to 50 bar, for example pressures within a range from 10 to 50 bar.

The volume of first compartment 10 is preferably below 20 litres, and may even be below 5 litres, below 3 litres, or may even be 1 litre or less.

In a preferred embodiment, the second compartment is designed for a pressure range from 1 bar up to 12 bar. More preferably, the pressure in the second compartment is in the range from 1.0 to 1.5 bar (which corresponds to 0-500 mbar overpressure); and even more preferably in the range from 1.0 to 1.1 bar (which corresponds to 0-100 mbar overpressure).

The volume of the second compartment is preferably up to 5 litres, and may even be up to 10 litres or 20 litres.

For the management of the logistics of refilling or recycling compartments 10, 11 of the vessel of the invention, appropriate volume and pressure combinations will be chosen for these compartments such that the number and ratio of first compartments 10 and second compartments 11 in the overall system of refilling/recycling is optimized. On the one hand, the number of compartments 11 will preferably take into account the time and effort required to clean and recycle the compartments 11, and the number of compartments 10, on the other hand, will take into account the time and effort required to refill compartments 10.

For example, if it takes half the time to fill a compartment 10 with fresh gas compared to the time it takes for the cleaning and recycling of a compartment 11, the number of fresh gas compartments 10 can be reduced in the overall refilling/recycling process. This has the further beneficial effect that the capital invested in vessels/compartments may be optimized.

In a more preferred embodiment, compartment 11 is filled with an adsorbent depending on the gas or gas mixture to be recovered.

For example, when the gas to be delivered and recovered is xenon (Xe), the second compartment 11 is preferably filled with zeolite as adsorbent. The zeolite could for instance be Silver-Lithium based exchange-zeolite, for example AgLiLSX, or mixtures thereof.

Further preferred adsorbents are molecular sieve MS13X or MS5A, activated charcoal, soda lime, or other adsorbents known to the skilled person.

The characteristics of the adsorbent have a direct influence on the size of, and pressure within, the second compartment. In a preferred embodiment, the amount and adsorption capacity of the adsorbent in the second compartment are selected such that the adsorbent in the second compartment is capable of adsorbing an amount of the gas to be recovered and stored which is equal to or higher than the amount of that gas contained in the first compartment.

In one embodiment, the amount and adsorption capacity of the adsorbent in the second compartment are selected such that the adsorbent is capable of adsorbing an amount of the gas to be recovered and stored which is higher than the amount of that gas contained in the first compartment. This will add to the safety and ease of use of the vessel according to the invention, since it ensures that all or essentially all of the gas dispensed from the first compartment can be recovered and stored in the second compartment.

In a further embodiment, the amount and adsorption capacity of the adsorbent in the second compartment are selected such that the adsorbent is capable of adsorbing an amount of the gas to be recovered and stored which is more than two times higher, more than three times higher, or more than 4 or more times higher than the amount of that gas contained in the first compartment. This will allow the user to use more than one, e.g., two, three, or more first compartments 10, which first compartments 10 would then be removably connected to the vessel, in combination with one and the same second compartment 11, thus again adding to the simplicity and convenience of use of the vessel according to the invention.

In a preferred embodiment the gas to be delivered comprises xenon (Xe), preferably in an amount of at least 10% by volume, more preferably at least about 30%, and still more preferably at least about 50% and most preferably at least about 70% by volume. Most preferably, the gas to be delivered comprises xenon (Xe) in an amount of about 80% by volume. The gas to be delivered preferably also comprises oxygen (O₂).

In a more preferred embodiment, the gas to be delivered consists predominantly of xenon (Xe) and oxygen (O₂) and preferably consists solely of xenon (Xe) and oxygen (O₂).

Preferably the gas to be recovered comprises xenon (Xe), preferably in an amount of at least about 5%, more preferably in an amount of at least about 10%, still more preferably in an amount of at least about 50% and most preferably about 70% by volume and especially about 80% by volume.

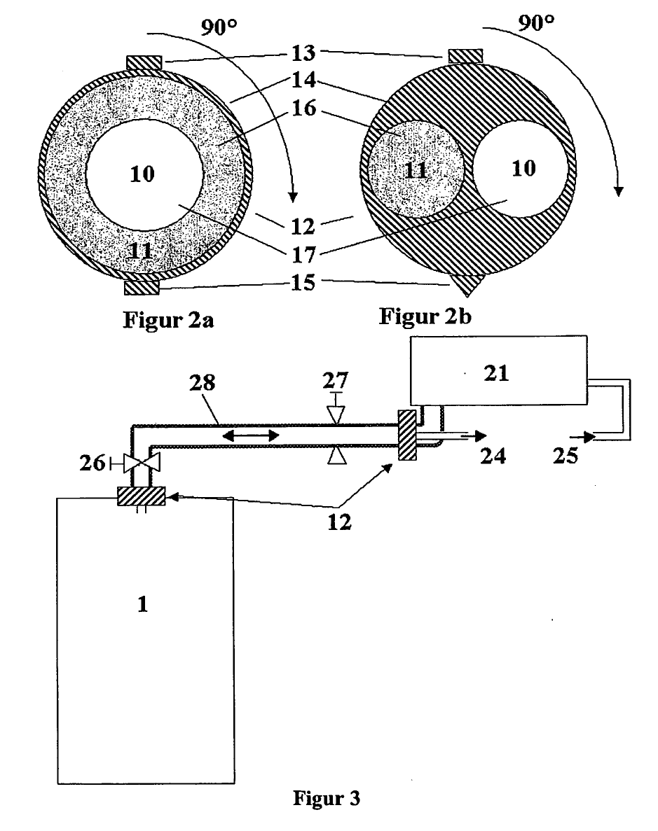

FIG. 2a and FIG. 2b show a plan view onto the end of a coupling showing two alternatives of combined coupling means 12 according to the invention.

The combined coupling means 12 are preferably quick couplings. In a preferred embodiment, the quick couplings are bayonet couplings, which may be opened and closed by rotation.

The rotation required for opening and closing of the couplings 12 is preferably greater than 45° and more preferably about 90°.

The coupling means 12 provide two connections 16, 17, which are for delivering gas from the first compartment 10 and feeding gas into the second compartment 11, respectively.

As shown in FIG. 2a the connection 17 is located within connection 16, whereas as shown in FIG. 2b the connections 16 and 17 may also be arranged in a parallel manner.

Connection 17 provides a connection to the first compartment 10, whereas connection 16 provides a connection to the second compartment 11.

The connections 16 and 17 as shown in FIG. 2a are preferably arranged in a coaxial manner.

The coupling means 12 are provided with locking means 13 and releasing means 15. The locking means 13 and releasing means 15 of the two embodiments shown in FIG. 2a and 2b differ so that only matching counter-couplings can be umnistakeably connected to couplings 12.

Although the vessel and the system are not limited in their usefulness to medical applications the invention will be described in the following with respect to a medical application.

FIG. 3 shows a system comprising a vessel according to the invention in a medical application.

Medical gases are used for different purposes. For example, nitrous oxides, xenon (Xe) and other gases are used in patients for anaesthesia.

Nitric oxide and carbon monoxide are used for their medicinal effects, e.g. in treating broncho- and vascoconstrictive or inflammatory conditions, and perfluorocarbons can be used, e.g., to cool the lungs of patients to induce artificial hypothermia. In many of these uses it is of importance to recover substantially all of the exhaled gases from a patient.

For anaesthesia, gases are delivered to the patients through a ventilator. The ventilator controls the flow of gas to the patient. The flow and composition of the gases are constantly measured either by the ventilator or by other control means.

The gas is delivered from a pressurised vessel to a ventilator. The gas can be delivered to the patient's lungs through a breathing mask or through an endotracheal tube.

A patient in need of only oxygen (O₂) as a medical gas can be equipped with a simple breathing mask without any requirements for recovery of an exhaled gas.

However, such an open system is not applicable to the use of rare and expensive gases, e.g., for anaesthesia with xenon (Xe), or to the use of gases, which may have toxic effects or are hazardous to the environment. For these gases, a closed or a substantially closed loop system is preferred.

The system can also be equipped with a number of connections for the addition of oxygen gas (which is needed to replace the oxygen (O₂) consumed by the patient during anaesthesia), medicaments or other medical gases.

Additionally, the system may comprise means for transporting and distributing the gas, such as pumps, valves, tubes etc.

A similar closed loop system is employed for generating artificial hypothermia in a patient, e.g., by application of pre-cooled perfluorocarbons or sulfur hexafluoride (SF₆).

The closed loop herein further comprises one or more heat exchanger units for cooling the gas before administering to the patient.

As used herein, the term “gas” or “medical gas” is intended to comprise pure gases, e.g. Nitrogen (N₂), Oxygen (O₂), perfluorocarbons, xenon (Xe), nitric oxide (NO) as well as gas mixtures, for example air, anaesthetic mixtures of oxygen (O₂) and xenon (Xe), mixtures of perfluorocarbons and oxygen (O₂) for inducing artificial hypothermia, wherein the mixtures may comprise additional compounds, e.g. carbon dioxide (CO₂) or gaseous water exhaled by the patient.

Loss of medical gas from a closed loop system may occur when the administration is started or finished. In both situations, it is necessary to flush the system several times with the medical gas (start of treatment) or with a breathing gas mixture in order to remove the medical gas from the patient's lungs (end of treatment).

Additionally, it is frequently required during the treatment to flush the system with medical gas to avoid enrichment of trace gases in the closed loop. The gas used for flushing of the system is normally not recovered and thus lost.

In a typical system for delivery and recovery of medical gases a vessel 1 is provided with a combined coupling means 12. The coupling means 12 is connected to means for conducting gas 28.

The means for conducting gas 28 may provide two parallel or almost parallel conduits or a conduit surrounded by another one. The means are chosen such that the configuration of the conduits is compatible with that of the connections comprised in the coupling means 12. The means for conducting gas 28 are provided at least at one side with a corresponding coupling means 12.

Furthermore the means for conducting gas 28 may be provided at appropriate locations with valves 26, 27 concerning one or both of the conduits.

For example, in FIG. 3, the system is provided with means for conducting gas 28, which is equipped with a valve 26 concerning the gas to be delivered and a second valve 27 concerning a gas to be recovered.

The gas to be delivered is accessible at a conduit 24, where further control means may be arranged for controlling the gas flow, for example according to an anaesthesia protocol.

For example, a dosing unit of a ventilator could be connected to conduit 24.

The gas to be recovered is fed into a conduit 25. For example an exhaust-gas exit of a ventilator could be connected to conduit 25.

The gas to be recovered may be subject to a pre-purification and/or drying process. The pre-purification may be performed by methods known in the art, e.g., by membrane purification, zeolites and/or PSA (pressure swing adsorption).

However, purification and/or drying of the gas may also be performed after the medical administration is finished, e.g. the gas may be stored intermediately.

Additionally, the purification and/or drying means may be located remotely to the system connected by the means for conducting gas 28.

When flushing the system, the fresh medical gas needed for this process is taken from the compartment containing the gas to be delivered, which gas is then delivered to the ventilator via means for conducting gas 28.

In the ventilator, the medical gas may be admixed to further gases (e.g., oxygen, air), and the flushing may be performed with the oxygen containing gas mixture.

The system may comprise a compressor or pump 21 between the conduit 25 and the vessel 1, depending on the gas to be recovered and whether the compartment for the recovery of a gas 11 is filled with an adsorbent or not.

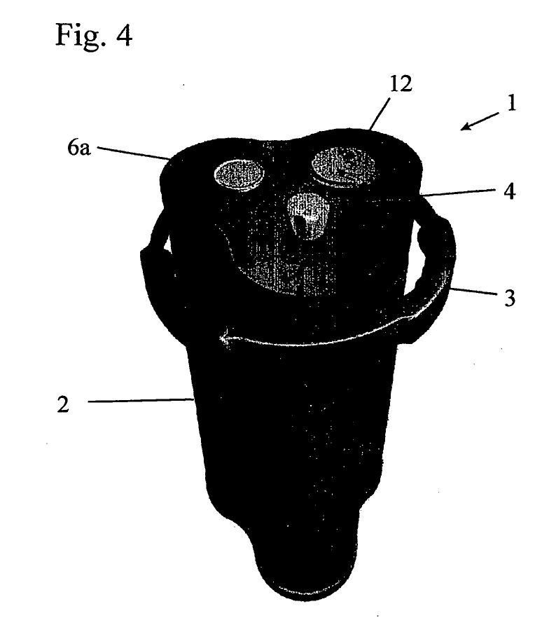

FIG. 4 shows a preferred embodiment of a vessel for dispensing and recovering of gases according to the present invention. The vessel 1 comprises an outer casing 2 surrounding the two compartments (not shown in this figure). A handle 3 is attached to the casing 2 to allow for easy handling and transport of the vessel 1.

The top of the casing 2 serves as a control desk, consisting of a window 6a, a combined coupling 12, and a fresh gas valve 4.

The combined coupling 12 is of the parallel type, i.e., the connection to deliver gas from the first compartment and the connection to feed gas into the second compartment are arranged next to each other in a parallel manner. A gas pipe (not shown) consisting of two separate tubes can be coupled to the combined coupling 12, connecting the vessel 1 to a inhalation device (not shown).

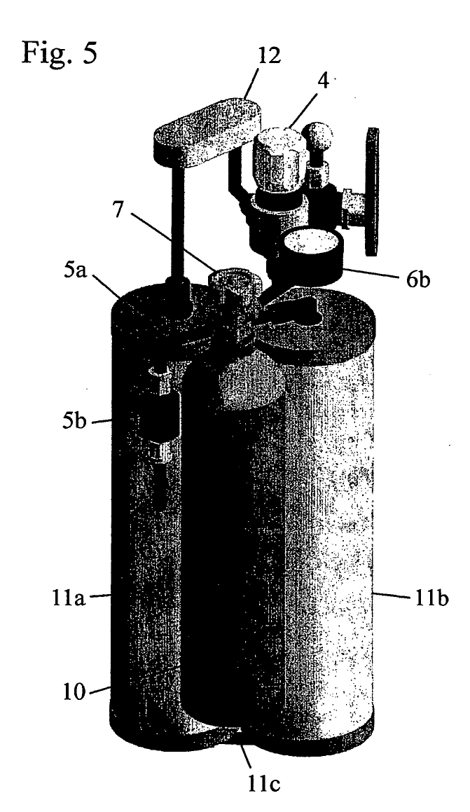

FIG. 5 shows another preferred embodiment of the invention, which could furthermore be combined, e.g., with an outer casing 2 as depicted in FIG. 4. The first compartment 10 of the vessel of FIG. 5 is a cylinder in which fresh xenon gas is stored. This could be, for example, an aluminum cylinder, e.g., a 1 liter/50 bar aluminum cylinder. A pressure reducing valve 7 is connected to the outlet port of the first compartment 10. In the particular example shown the pressure reducing valve 7 is, for the sake of safety, not accessible from the outside, and therefore, cannot be easily manipulated, e.g., by a user lacking special technical training. After the pressure reducing valve 7 a manometer 6b is installed which is visible through the window 6a shown in FIG. 4. A fresh gas valve 4 installed between the manometer 6b and the combined coupling 12 and accessible from the outside even if the casing 2 is closed (as can be seen in FIG. 4) allows for controlling the pressure of the fresh xenon gas supplied to the inhalation device

The second compartment, by which used gas exhaled by the patient is received, consists of two adsorbent containers 11a, 11b, which could be, for example, made from aluminum, e.g., two 2.5 litre aluminum containers. The two containers 11a and 11b are connected to each other through gas pipe 11c. Used gas first flows through the first container 11a and afterwards through the second container 11b, thereby ensuring an effective contact of the used gas with the adsorbent.

The second container 11b comprises an outlet port 5a with a non return valve 5b where waste gas which was not adsorbed by the adsorbent leaves the second compartment. The adsorbent may consist, e.g., of a total of 3.5 kg of a zeolite (1.75 kg per adsorbent container) and is generally suitable to adsorb xenon which is contained in the used gas. Thereby, the used xenon is recovered and stored in the two containers of the second compartment whereas the remaining gas/es, which has/have been separated from xenon, is/are released into the ambient air (or into the evacuation system of, e.g., an operation room) after completing the adsorption process. In order to purge the adsorption material, the outlet may be equipped with a connector for purging gas (not shown).

3.5 kg of the zeolite molecular sieve 5A would have a capacity to adsorb about 80 litres of xenon under ambient conditions. Starting from the above exemplary amount of fresh gas to be dispensed from the first compartment, it would thus be ensured that the adsorption capacity of the second compartment is sufficient to ensure adsorption of all, or essentially all, of the xenon gas previously dispensed from the first compartment.

Since the two compartments are separated from each other, a change of the xenon gas cylinder 10 is possible if it is empty, without having to exchange the adsorbent containers as well.

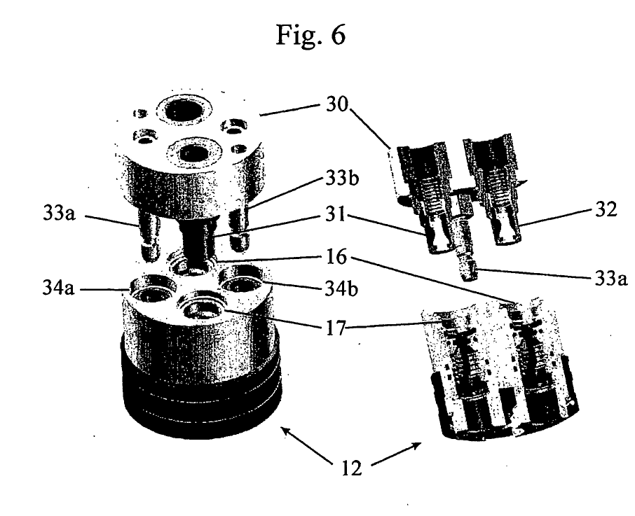

FIG. 6 shows a preferred embodiment of the coupling means 12 together with a corresponding counterpart 30 to which two tubes (not shown) are attached which lead to the inhalation device.

The coupling means 12 comprises two connections 16, 17. Connection 17 provides a connection to the first compartment 10, whereas connection 16 provides a connection to the second compartment. Connections 16 and 17 engage their respective counterparts 32 and 31 in an airtight manner to ensure that no gas is lost from or added to the gas mixture delivered to the patient.

For further securing the mechanical connection between coupling means 12 and its counterpart 30, counterpart 30 is provided with two pins 33a, 33b which engage corresponding holes 34a , 34b in the coupling means 12, respectively. The pins and holes are preferably designed in different dimensions to ensure an unmistakenly correct orientation.

1. A vessel for dispensing and recovering of gases, in particular technical and medical gases, the vessel comprising:
a first compartment for storing and dispensing a gas, and a second compartment for recovering and storing a gas, and coupling means for providing a connection to deliver gas from said first compartment and for providing another connection to feed gas into said second compartment, characterized in that said second compartment comprises an adsorbent.

2. The vessel according to claim 1, wherein said coupling means is a combined coupling for providing a connection to deliver gas from said first compartment and another connection to feed gas into said second compartment.

3. The vessel according to claim 1, wherein said coupling means is a quick coupling.

4. The vessel according to claim 3, wherein said quick coupling is a bayonet coupling.

5. The vessel according to claim 1, wherein the connection to deliver gas from the first compartment is located within said other connection.

6. The vessel according to claim 1, wherein the connection to feed gas into the second compartment is located within said other connection.

7. The vessel according to claim 4, wherein the connections are arranged in a coaxial manner.

8. The vessel according to claim 1, wherein the connections are arranged in a parallel manner.

9. The vessel according to claim 1, wherein the second compartment is located within the first compartment.

10. The vessel according to claim 1, wherein the first compartment is located within the second compartment.

11. The vessel according to claim 1, wherein the first and the second compartments are located adjacent to each other.

12. The vessel according to claim 1, wherein the absorbent comprises molecular sieve 13X or 5A; activated charcoal; or soda lime.

13. The vessel according to claim 1, wherein the adsorbent is a zeolite.

14. The vessel according to claim 13, wherein the zeolite is AgLiLSX.

15. The vessel according to claim 1, wherein at least one of said compartments is designed for a pressure range from 10 to 200 bar.

16. The vessel according to claim 1, wherein at least one of said compartments is designed for a pressure range from 1 bar up to 12 bar.

17. The vessel according to claim 1, wherein at least one of said compartments comprises a volume of up to 20 litres.

18. The vessel according to claim 1, wherein at least one compartment, contains a gas comprising a gas selected from the group consisting of CO, NO, a halogen, e.g., chlorine, SF₆, CF₄, Ne, Ar, Kr, Xe, a perfluorocarbon, He, O₂, N₂, and CO₂.

19. The vessel according to claim 1, wherein the first compartment is removably connected to the vessel.

20. The vessel according to claim 1, wherein the second compartment is removably connected to the vessel by coupling means.

21. The vessel according to claim 10, wherein said coupling means for removably connecting the second compartment to the vessel is a quick coupling.

22. The vessel according to claim 21, wherein said quick coupling is a bayonet coupling.

23. The vessel according to claim 20, wherein said coupling means for removably connecting the second compartment to the vessel is a threaded coupling.

24. The vessel according to claim 1, wherein the second compartment comprises at least two adsorbent containers.

25. The vessel according to claim 1, wherein the amount and adsorption capacity of the adsorbent in the second compartment are selected such that the adsorbent in the second compartment is capable of adsorbing an amount of the gas to be recovered and stored which is equal to or higher than the amount of that gas contained in the first compartment.

26. The vessel according to claim 25, wherein the amount and adsorption capacity of the adsorbent in the second compartment are selected such that the adsorbent is capable of adsorbing an amount of the gas to be recovered and stored which is more than two times higher than the amount of that gas contained in the first compartment.

27. A system for the delivery and recovery of gases for medical or technical applications, said system comprising
a vessel for dispensing and recovering of gases according claim 1,
means for delivering the gas from the first compartment of the vessel for an application,
means for recovering gas from the application, and
means for conducting gas from and to the vessel.

28. The system according to claim 27, wherein the means for conducting gas from the vessel are located within the means for conducting gas to the vessel.

29. The system according to claim 27, wherein the means for conducting gas to the vessel are located within the means for conducting gas from the vessel.

30. The system according to claim 28, wherein the means for conducting gas from and to the vessel are arranged in a coaxial manner.

31. The system according to claim 27, wherein said means for delivering is a ventilator system.

32. The vessel according to claim 1, wherein at least one of said compartments is designed for a pressure range up to 50 bar.

33. The vessel according to claim 1, wherein at least one of said compartments is designed for a pressure range from 10 to 50 bar.

34. The vessel according to claim 1, wherein at least one of said compartments is designed for a pressure up to 12 bar.

35. The vessel according to claim 1, wherein at least one of said compartments is designed for a pressure in the range from 1.0 bar to 1.5 bar (0 to 500 mbar overpressure).

36. The vessel according to claim 1, wherein at least one of said compartments is designed for a pressure in the range from 1.0 bar to 1.1 bar (0 to 100 mbar overpressure).

37. The vessel according to claim 25, wherein the amount and adsorption capacity of the adsorbent in the second compartment are selected such that the adsorbent is capable of adsorbing an amount of the gas to be recovered and stored which is more than three times higher than the amount of that gas contained in the first compartment.

38. The vessel according to claim 25, wherein the amount and adsorption capacity of the adsorbent in the second compartment are selected such that the adsorbent is capable of adsorbing an amount of the gas to be recovered and stored which is more than four times higher than the amount of that gas contained in the first compartment.
